(19) United States
(12) Patent Application Publication
(10) Pub. No.: US 2007/0058634 A1
(43) Pub. Date: Mar. 15, 2007

(54) Interaction with wireless sensor devices

(76) Inventors: Vipul Gupta, Los Altos, CA (US); Michael Wurm, Graz (AT)

Correspondence Address: SUN MICROSYSTEMS, INC.;ATTN: TIMOTHY SCHULTE, ONE STORAGETEK DRIVE, MS 4309, LOUISVILLE, CO, 80028-4309, US

(21) Appl. No.: 11/236,435

(22) Filed: Sep. 27, 2005

Related U.S. Application Data
(60) Provisional application No. 60/715,438, filed on Sep. 9, 2005.

(51) Int. Cl. H04L 12/56

(52) U.S. Cl. 370/392; 370/401

(57) ABSTRACT

A client node is communicatively coupled to a gateway node via a TCP/IP network. One or more constrained devices that include a wireless receiver/transmitter circuit communicate with the gateway node via a wireless network. The gateway node includes a web server that provides a dynamic web page accessible by the client node that has a list of the one or more active constrained devices on the wireless network. Each device entry in the list includes a URL that acts as an entry point for the client node to communicate with a web server in a corresponding constrained device. The gateway node automatically discovers a new device on the wireless network and populates the list of the one or more active constrained devices with the newly present constrained device. The new constrained device may be detected based on a periodic message sent by the constrained device indicating the constrained device has turned on its receiver/transmitter circuit for a period of time.

### CROSS-REFERENCE TO RELATED APPLICATION(S)

This application claims the benefit of provisional application 60/715,438, filed Sep. 9, 2005, entitled “Energy Cost of SSL on Wireless Sensors”, naming Michael Wurm and Vipul Gupta as inventors, which application is incorporated herein by reference in its entirety.

### BACKGROUND

1. Field of the Invention

This invention relates to wireless sensor devices and more specifically to communication with wireless sensor devices.

2. Description of the Related Art

In recent years, a single development—the introduction of network-enabled cell phones was responsible for doubling, between 2001 and 2003, the number of devices connected to the WorldWide Web. As impressive as this trend has been to date, industry watchers predict an even more dramatic increase in the next few years. Today more than 3 billion devices have Web access, and that number is expected to grow to 14 billion within five years, driven primarily by the proliferation of tiny, battery-powered, wireless sensor devices capable of monitoring temperature, vibration, light intensity, moisture, vital signs, etc. Industrial, agricultural, health care, environmental, security, and military users, among others, are beginning to recognize how wireless sensors can revolutionize their operations. As these devices become available at commodity prices, staggering numbers of them will start turning up everywhere imaginable.

These devices typically lack a display or input mechanism for direct interaction with users and those users are often unskilled in managing and administering computer systems. Thus, interaction with these devices can be challenging. As the number of potential applications for tiny, battery-powered, “mote”-like, wireless sensor devices grows, so does the need to simplify and secure interactions with these devices.

### SUMMARY

Accordingly, it would be desirable to provide improved interaction capability with such devices. One aspect of improved interaction capability is to provide a user-friendly mechanism for discovering available wireless sensor devices and for monitoring and configuring them. A small web server can be utilized on the highly constrained sensor devices that supports both HTTP and HTTPS and runs efficiently within the tight computing, networking and memory constraints of mote-like sensor devices. By integrating a secure web server into a sensor device, one can interact with the wireless sensor devices simply and easily using a web browser. Besides the advantage of a familiar user interface and platform independence, this approach also offers well established and familiar communication security in the form of SSL, a protocol supported by virtually every browser. With the addition of an application-level, duty-cycle based approach to low-power listening for incoming service requests to the web server on the highly constrained device, significant improvements can be made power conservation while preserving the ability to interact conveniently, while providing a convenient discovery mechanism.

In one embodiment a method provides a dynamic web page in a web server of a gateway that is accessible by a client node communicatively coupled to the gateway node by a first network. The dynamic web page lists one or more constrained devices communicatively coupled to the gateway node over a second network, the second network being wireless. A URL associated with each device in the list of devices is used by the client node as an entry point to communicate with a web server on one of the constrained devices. In an embodiment, the gateway node discovers a constrained device that is newly present on the wireless network absent a request from the client node; and lists the newly present constrained device on the list. In an embodiment the gateway node is configured to automatically discover a constrained device that is newly present on the wireless network utilizing a periodically sent message as an indicator of the presence of a constrained device and to populate the list of the one or more constrained devices with the newly present constrained device.

### BRIEF DESCRIPTION OF THE DRAWINGS

The present invention may be better understood, and its numerous objects, features, and advantages made apparent to those skilled in the art by referencing the accompanying drawings.

FIG. 1 illustrates an exemplary gateway-based architecture.

FIG. 2 illustrates an exemplary gateway-based architecture using a multi-hop topology for the sensor devices.

FIG. 3 illustrates an high level illustration of an exemplary screen presentation according to an embodiment of the invention.

FIG. 4 illustrates exemplary secure traffic with a wireless sensor device.

FIG. 5 illustrates power consumption associated with remote sensor device polling.

The use of the same reference symbols in different drawings indicates similar or identical items.

### DESCRIPTION OF THE PREFERRED EMBODIMENT(S)

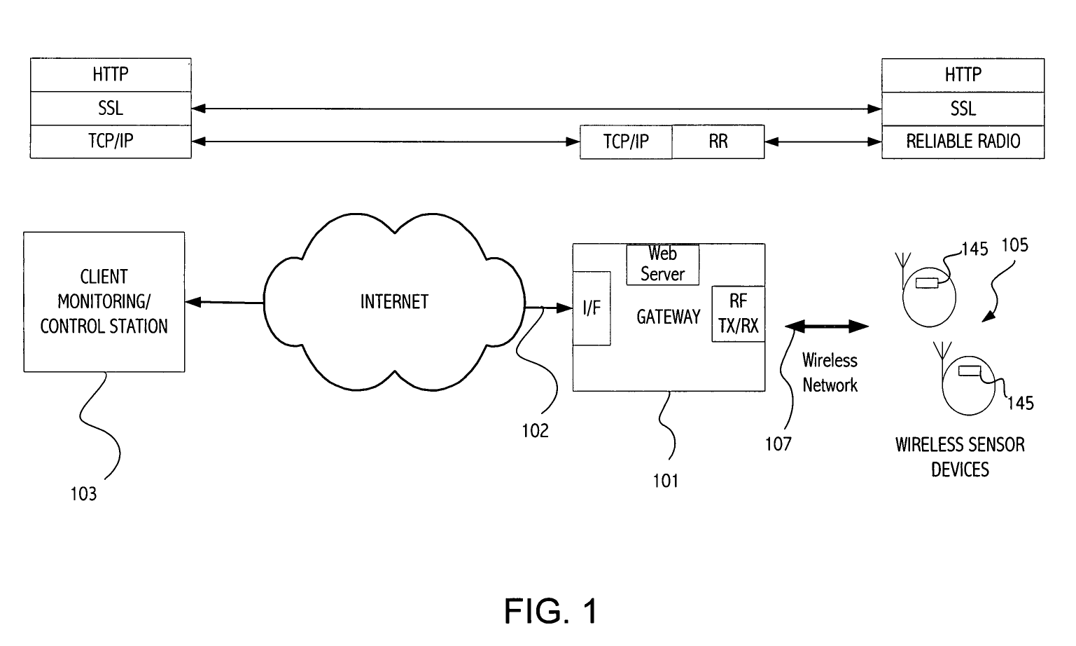

Referring to FIG. 1, an exemplary gateway-based architecture makes constrained devices such as wireless sensor devices available from the Internet. FIG. 1 illustrates a star topology in which a central device 101 is connected to a client 103 such as a personal computer via a network 102, typically a fast high bandwidth network such as Ethernet or Wifi. The central device 101 acts as a gateway, forming a bridge between the TCP/IP network on one side (or other appropriate protocol) and a wireless sensor network (e.g., IEEE 802.15.4) on the other to communicate with wireless sensor device(s) 105 on the other side of the gateway. While in many embodiments the wireless sensor network is RF, other embodiments may use infrared or other wireless technology. Each wireless sensor device may be mapped to a different TCP-port on the gateway and users can communicate with the with the web server stack running on the wireless sensor device via a standard web browser. An exemplary gateway device may be comprised of a personal computer or server that has the capability of interfacing to a high speed network on one side and the wireless network on the other and performing appropriate translations between the protocols utilized on the two networks. Such functionality is well known in the art.

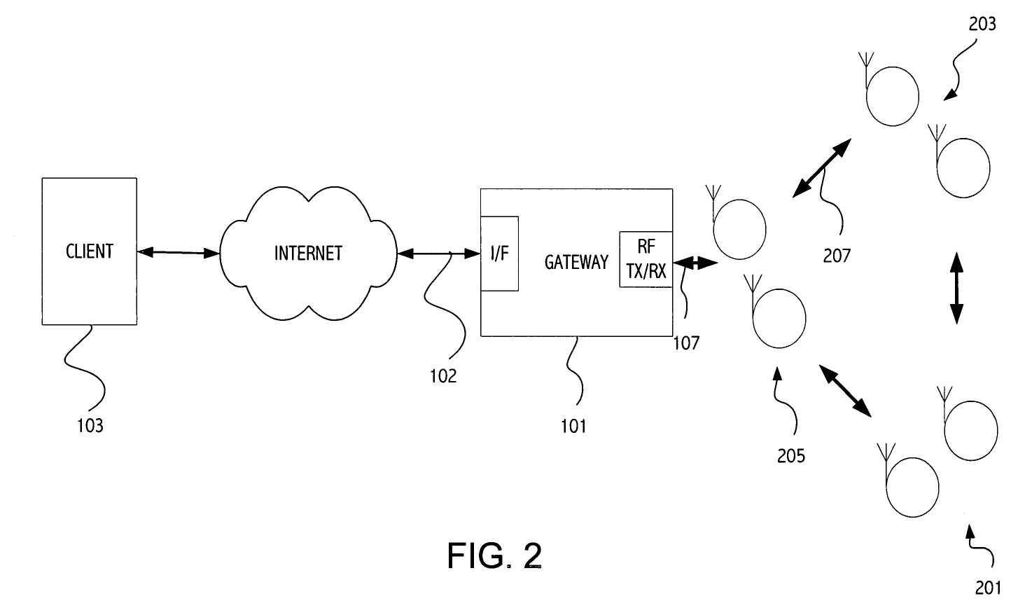

Referring to FIG. 2, another embodiment utilizes a multi-hop mesh topology for the wireless sensor devices. The wireless sensor devices 201 and 203 communicate with gateway 101 through wireless sensor devices 205. For example, embedded device 203 may communicate directly over wireless link 207 with one of the wireless sensor devices 205, which in turn retransmits the received packets over wireless link 107 to gateway 101. While a maximum of two hops is illustrated in FIG. 2, e.g., from wireless sensor devices 201 to 203 to 205, the number of hops is not limited to one or two hops as illustrated. For communications from gateway 101 packets destined for wireless sensor devices 201 and 203, may be first transmitted over wireless link 107 to wireless sensor devices 205.

Exemplary wireless sensor devices typically range in size from a large coin to a matchbox and are equipped with inexpensive 8- or 16-bit processors and a small amount of memory, e.g., 4KB to 10KB of RAM. Exemplary wireless sensor devices include a family of sensor platforms such as Telos, called “motes” running an operating system call TinyOS. Another example of a wireless sensor device is a WINS node, which is a StrongARM based wireless sensor developed at Rockwell Scientific. Such wireless sensor platforms typically include an ultra-low-power microcontroller. An embodiment of the invention may utilize the Telos (Rev B) “mote” as the wireless sensor device, which has a 16-bit CPU and an IEEE 802.15.4 radio. The Telos mote is powered by two AA batteries and application-specific sensors can be attached to digital and analog input pins or to an I2C bus interface. The Telos motes are the successors to the Mica family of motes (Mica2dot, Mica2 and MicaZ) and offer greater computing power and higher radio bandwidth (compared to the Mica2dot and Mica2). They are equipped with 16-bit CPU, rated for 8 MHz, and an IEEE 802.15.4 compatible radio, and an onboard USB connector to download applications.

As described above, the client node 103 may communicate with the wireless sensor devices via a standard web browser. A simplified view of the World Wide Web consists of servers, called web servers that respond to requests from clients, called web browsers, for specially formatted data called a web page. Web pages are typically written in HTML and transported over a protocol called HTTP or its cryptographically secure variant called HTTPS. Web pages can display text in different styles and formats (lists, tables, etc.), can embed images and also include links to other pages that may be followed by simply clicking on the associated key word or phrase.

Manufacturers of networked devices like broadband/DSL routers, firewalls, WiFi bridges, and network printers have been embedding small web servers allowing these devices (many of which do not have any direct means of user interaction) to be monitored and controlled via a browser. Information such as device description and operating instructions is included in the form of static web pages. The embedded web server can also generate pages dynamically containing real-time information about the device, e.g. the filtering rules configured in a firewall or the status of a printer's queue. Furthermore, the use of HTML forms allows a user to change settings and configure these devices via a browser.

One can create a tiny web server (capable of both HTTP and HTTPS communication) that can fit within the tight computational, networking and storage constraints of wireless sensor devices. In one embodiment, the tiny web server implements a number of optimizations for reducing resource usage while maintaining compatibility with standard SSL. It supports 1024-bit RSA and 160-bit ECC (which provides equivalent security) as well as SHA1, MD5 and RC4. These cryptographic algorithms are written in C except for the most time critical portions (e.g., big integer operations) which are written in assembly language. An exemplary web server suitable for use on the wireless sensors described herein is described in “Sizzle: A Standards-based End-to-end Security Architecture for the Embedded Internet,” Third IEEE International Conference on Pervasive computing and Communications (PerCom), March 2005, Kauai, Hi.” and in the patent application entitled “Method and Apparatus for Reducing Bandwidth Usage in Secure Transactions,” application Ser. No. 11/072,061, filed Mar. 4, 2005, naming Vipul Gupta et al. as inventors, which application is incorporated herein by reference. Having such a web server enables devices like home appliances, personal medical devices, industrial sensors, utility meters, etc. to be monitored and controlled across the Internet. In addition, the use of HTTPS provides strong cryptographic security, including confidentiality, data integrity, authentication and access control, where needed. The web servers 145 on the wireless sensor devices connect to the Internet through the gateway.

Before a user can interact with the web server embedded within a device, the user needs to first determine the IP address or URL where the server is located. Consider a scenario, where a homeowner brings home a newly purchased network-capable device, such as a thermostat or other wireless sensor type device. It would be desirable to simplify the task of finding the embedded web server on the wireless sensor device.

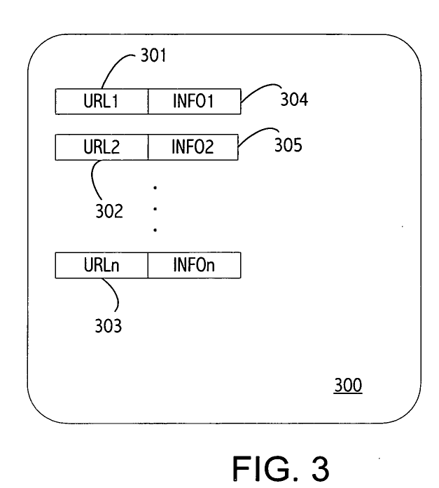

The web server at the gateway creates a dynamic web page listing devices currently on the wireless network, e.g., currently active devices. Each entry includes a URL that acts as an entry point for interacting with the web server embedded inside that device. Referring to FIG. 3, a high level block diagram of a dynamic page listing 300 is illustrated showing a number of entries 301, 302, 303 having URL information for a particular wireless sensor device. In addition, device entries in the list may also include discovered information 304, 305 such as the device name, manufacturer, serial number, etc. After turning on a device, the user directs his web browser to the fixed URL of the “device listing” page. Clicking the link, e.g., URL1, brings up the starting web page for the associated wireless sensor device with overview information and additional links for monitoring and/or configuring the device. In an embodiment, the web server on the constrained wireless platform supports user authentication using passwords over SSL and this can be used to implement device-specific access control policies.

In an embodiment, the gateway device has functionality so that it can discover new devices as they are introduced and update the dynamic web page that lists the known devices. The specific details of discovery protocols are known in the art, for example, one could reuse an existing discovery protocol like Universal Plug and Play (UPnP), Service Location Protocol (SLP), Bonjour or another variant. Using a discovery mechanism to create a dynamic page listing a universal resource locator (URL) that acts as an entry point into the newly discovered device simplifies user interaction with the device.

Assuming a user has just installed a new device, after turning on the device, the user directs a web browser to a fixed URL on the gateway where all known devices are listed. After the device is discovered, it automatically appears in the list of known devices with a link to its embedded web server. Clicking the link brings up the starting web page for the device with overview information and additional links for monitoring and/or configuring the device. The URL information associated with the newly discovered device can either be registered explicitly by the sensor device as part of the discovery protocol or known directly to the gateway either because it assigns the IP address to the sensor device (the gateway may also act as a DHCP server) or maps the sensor device web server to an available TCP port number at its own IP address. With this new functionality, the overall user experience in integrating a newly purchased device is greatly simplified. The “device listing” web page on the gateway may use the refresh meta tag causing the browser to periodically reload this page thereby eliminating the need for any explicit user action for discovering a newly introduced device.

The web server implementation may be individually tailored for each device. For example, the web server inside a thermostat may have a page with the current temperature and buttons to choose between off/cold/heat settings, while a web server inside a GPS-enabled bracelet may have a page detailing recent movements of the wearer. Depending on the particular application, a web page may need to be sent securely and only to appropriately authenticated users.

In an embodiment, a sensor device can initiate communication (in contrast, a server simply responds to requests for information). This functionality is useful in sending out urgent notifications. For example, a chemical plant operator may find it more useful to have an industrial sensor send out a notification upon detecting a measurement outside of the normal range compared to sitting in front of a browser periodically monitoring that sensor. Notifications may be communicated in any number of ways, e.g., as an email or SMS message and may be secured (when needed) through one of several possible mechanisms including S/MIME (which provides message level security) or SSL (which secures the message only when it traverses the protected channel). The device may initiate data transfers on its own instead of polling for incoming requests to save energy associated with idle listening. In such an embodiment, the device accumulates sensor readings in a buffer and transmits them whenever that buffer is full. Embodiments may utilize a combination of idle listening and initiation of communication by the sensor device according to system requirements.

Many of the wireless sensor devices are powered by batteries and maximizing battery lifetime can be crucial to keep maintenance costs low. In an embodiment reducing the energy spent by the sensor device while in idle listening for incoming service requests can also be used to provide for discovery capability as described further herein. However, other sensor devices may have a power source available. For example, a sensor device may be embedded in an appliance and have power available but the sensor device still may be resource constrained and lack network capability other than through an RF link. Thus, to refer to devices generically, the term “constrained device” is used herein. Constrained device refers a device, typically a remote sensing device that is constrained in terms of various factors such as a user's ability to interact with it and has a wireless link with which to communicate. In typical situations, the constrained device is sensitive to power consumption, and has limited processing power and memory as is true of many embedded devices. The device may be constrained in terms of one or more constraints such as, available memory, processing power, available energy, user interaction capability, network bandwidth, network stability.

Radio communication is significant contributor to the total energy consumption in a wireless sensor system. Low-power, wireless networking standards, such as IEEE 802.15.4, have a goal to minimize active listening, i.e., the time a radio spends in receive mode to detect network traffic, by employing duty-cycle based schemes. This may be done by synchronizing the communicating parties to use only certain time slots, or with the help of special hardware functionality which allows a radio to detect traffic while staying in a low power mode most of the time.

Unfortunately, some implementation of IEEE 802.15.4 may not offer hardware support for low power listening. An alternative approach, described herein, conserves energy at the application level. That results in a scheme that is simple, portable across different radio platforms, and customizable for specific applications.

In an embodiment, a special reliable data transfer protocol is used between the gateway and sensor devices. This protocol runs directly on top of the operating system radio stack and ensures loss-less, in-order delivery of messages whose size is limited only by available buffer space. A long message may be split into multiple, fixed-size packets and the receiver explicitly acknowledges the first and the last packets. Remaining packets are transmitted using a NACK scheme to avoid the overhead of acknowledging every single packet.

In order to minimize the overhead of sending multiple short messages, the gateway may buffer TCP segments until a complete SSL record (or plain HTTP request) has been assembled before forwarding it. The sensor device processes the data received and either sends additional data in response (e.g., when responding to the ClientHello with a combined ServerHello, Certificate and ServerHelloDone message or when responding to an HTTP request with an HTTP response) or transmits a “ready” control message to indicate its readiness to process the next chunk of data (e.g., when waiting for the ChangeCipherSpec message after processing the ClientKeyExchange). In the former situation, data transmission from the sensor is an implicit signal to the gateway that the sensor is ready to receive the next chunk of information.

The SSL protocol offers encryption, authentication and integrity protection on top of a streaming data-transport mechanism like TCP. It allows communicating parties to choose a set of cryptographic algorithms, called a cipher suite, which determines the method of key exchange, signature verification, encryption and keyed hashing (to detect data tampering). Cipher suites that use ECC-based key exchange have been defined for SSL. While ECC support is currently not included in binary distributions, it can be enabled in the source code of the Mozilla/Firefox browsers as well as the Apache web server.

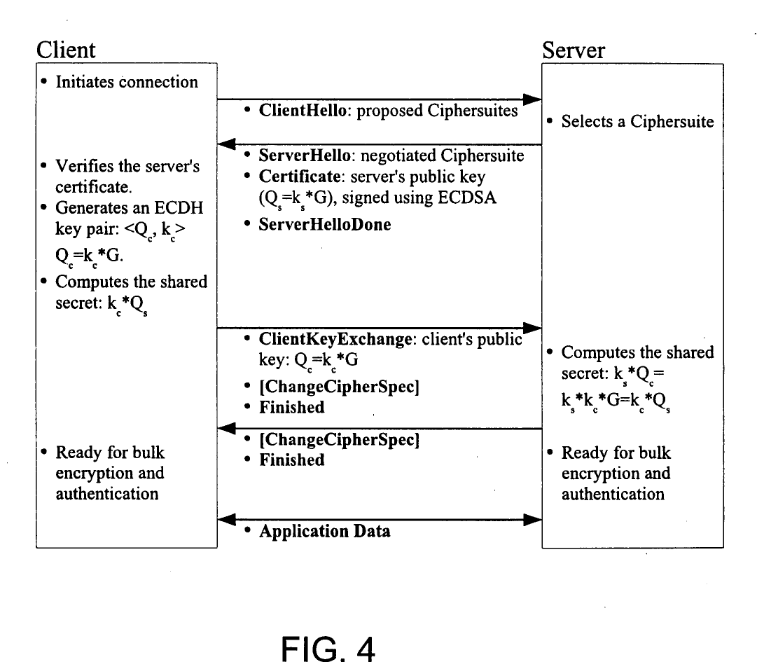

The two main components of the SSL protocol are the Handshake protocol and the Record Layer protocol. In the handshake, both parties agree on a cipher suite, authenticate each other and establish a shared secret using public-key cryptography (see FIG. 4). The record layer uses symmetric keys, derived from the shared secret, to perform bulk encryption and authentication of application data. Since public-key cryptography is expensive, SSL supports abbreviated handshakes, where the parties reuse a shared secret established in a previous full handshake. FIG. 4 shows an exemplary Minimal ECDH-based SSL Handshake. The most computationally expensive part is the ECC point multiplication, which occurs when the server processes the ClientKeyExchange message.

Power consumption may be a critical component of battery powered remote sensing devices. Table 1 shows measured current draw (in mA) for common operating modes of an exemplary wireless sensor device (Telos mote) at different supply voltages with the CPU operating at 8 MHz. As can be seen in Table 1, in the overall system, the radio consumes considerably more energy than the CPU, and the receive mode draws more current that the transmit mode. Since the radio must be in receive mode to listen for packets, special care should be taken to minimize idle listening in energy constrained applications.

TABLE 1

| Vcc | Idle | CPU | Radio-RX | Radio-TX | CPU + Radio-RX |
|---|---|---|---|---|---|
| 2.2 | 0.004 | 2.1 | 20.5 | 17.2 | 22.6 |
| 2.6 | 0.006 | 3.0 | 20.6 | 17.2 | 23.6 |
| 3.0 | 0.008 | 3.9 | 20.6 | 17.3 | 24.5 |

Given that the radio consumes energy at a much higher rate than the microcontroller, it is desirable to turn off the radio whenever possible. Normal web servers are always on and ready to receive incoming TCP connection requests. If such a web server were to use a duty cycle based approach—sleeping most of the time and waking up only periodically—TCP packets delivered to the web server when it is asleep would not be acknowledged. The TCP stack on the client would incorrectly interpret packet loss as a sign of network congestion and unnecessarily throttle back its transmission rate.

The exemplary architecture shown in FIG. 1 terminates the TCP connection at a mains-powered (hence, always on) gateway. In an embodiment, the gateway only sends data to a sensor if it has recently received some data or the “ready” control message indicating that the remote sensor device is ready to receive data. That makes it easy to have the sensor go to sleep without worrying about data loss. For example, the sensor can turn off its radio while processing the ClientKeyExchange SSL record (this can take a few seconds if an RSA decryption is involved) knowing that the gateway won't transmit the ChangeCipherSpec message until the sensor turns on its radio again and transmits a “ready” message.

In an embodiment, the wireless protocol includes a “ready-sleep” message used across the wireless link 107 in FIG. 1. The “ready sleep” message is sent by the sensor to inform the gateway that the sensor has turned on its radio for a short period, but if the gateway does not initiate a new service request (for an SSL handshake or HTTP(S) data transfer) during this period, the sensor will turn off the radio and go to sleep. The sensor sleeps most of the time but wakes up periodically and sends the “ready-sleep” message to poll the gateway for pending service requests. If the gateway does not respond within a short time period, the sensor powers down again. Exploiting the ready sleep message, the gateway may hold requests for a new connection or data transfer from a client until the constrained device wakes up and processes that request. Thus, a client node request for access to the constrained device web server can be held until the ready-sleep message is received.

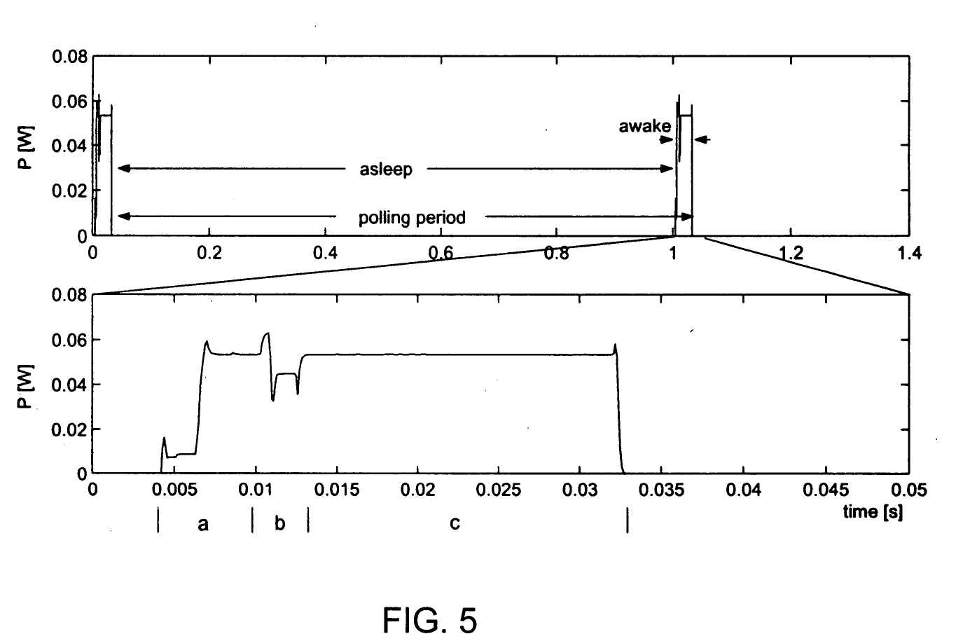

FIG. 5 illustrates measured power consumption while the wireless sensor device polls the gateway for pending service requests. During the period (a) the CPU wakes up and activates the radio. During (b) the wireless sensor device transmits the “ready-sleep” message and leaves its radio turned on for a short period. At (c) if the gateway does not respond during the short period, the mote powers down again. In one embodiment, each polling attempt consumes roughly 1.5 mJ of energy. In an embodiment staying awake and listening for 20 ms gives the gateway enough time to respond.

The fact that each device periodically transmits “ready-sleep” messages, can be used by the gateway to discover the presence of active sensors in its neighborhood. Thus, after detecting a ready-sleep message from a newly installed device, the web server at the gateway updates its dynamic web page listing of currently active devices. The rate at which the web server in the wireless sensor device polls the gateway for pending service requests can be lengthened to lower average energy consumption at the expense of increasing response latency and vice versa. In an embodiment, since each poll consumes roughly 1.5 mJ of energy, 10% of the available battery capacity (typical capacity of a pair of Alkaline batteries used in one embodiment is 2.6 Ah) can power nearly one million polls. For a desired battery lifetime of 500 days, this translates to 2,000 polls per day or one poll every 45 seconds.

The embodiments described above are presented as examples and are subject to other variations in structure and implementation within the capabilities of one reasonably skilled in the art. The details provided above should be interpreted as illustrative and not as limiting. Variations and modifications of the embodiments disclosed herein, may be made based on the description set forth herein, without departing from the scope of the invention as set forth in the following claims.

What is claimed is:

1. An apparatus comprising:
a gateway node;
a client node communicatively coupled to the gateway node via a first network;
one or more constrained devices including a wireless receiver/transmitter circuit to communicate with the gateway node via a wireless network; and
wherein the gateway includes a web server and the gateway web server is coupled to provide a dynamic web page accessible by the client node having a list of the one or more active constrained devices on the wireless network.

2. The apparatus as recited in claim 1 wherein each device entry in the list includes a URL that acts as an entry point for the client node to communicate with a corresponding constrained device.

3. The apparatus as recited in claim 1 wherein the list of the one or more constrained devices includes universal resource locator (URL) information for the one or more constrained devices and a web server on the constrained device is accessible by the client through the gateway.

4. The apparatus as recited in claim 1 wherein the gateway node is configured to present information additional to the URL information for the one or more constrained devices, the additional information including at least one of name, manufacturer information, serial number, and current status.

5. The apparatus as recited in claim 1 wherein the gateway translates TCP/IP traffic between the client node and the gateway node into an application specific protocol for communication between the gateway node and the one or more constrained devices.

6. The apparatus as recited in claim 1 wherein the gateway node is configured to automatically discover a constrained device that is newly present on the wireless network and to populate the list of the one or more active constrained devices with the newly present constrained device.

7. The apparatus as recited in claim 6 wherein URL information for the newly present constrained device is presented in the list.

8. The apparatus as recited in claim 1, wherein the constrained device is configured to periodically wake up from a low power state in which the wireless receiver/transmitter circuit is turned off and to sends a message to the gateway node indicating that the constrained device has turned on its receiver/transmitter circuit for a period of time.

9. The apparatus as recited in claim 8 wherein the constrained device returns to a low power state in which the wireless receiver/transmitter circuit is turned if no transmission is initiated to the constrained device during the period of time.

10. The apparatus as recited in claim 8 wherein the gateway node is configured to automatically discover a constrained device that is newly present on the wireless network and to populate the list of the one or more active constrained devices with the newly present constrained device utilizing the message as an indicator of the presence of a constrained device.

11. A method comprising:
providing a dynamic web page in a gateway node that includes a web server that is accessible by a client node communicatively coupled to the gateway node by a first network, the dynamic web page having a list of one or more constrained devices communicatively coupled to the gateway node over a second network, the second network being wireless.

12. The method as recited in claim 11 further comprising displaying a URL in each device entry in the list on the dynamic web page.

13. The method as recited in claim 12 further comprising the client node using the URL as an entry point to communicate with a web server on one of the constrained devices.

14. The method as recited in claim 12 further comprising presenting information additional to the URL information for the one or more constrained devices, the additional information including at least one of name, manufacturer information, serial number, and current status.

15. The method as recited in claim 11 further comprising:
the gateway node discovering a constrained device that is newly present on the wireless network absent a request from the client node; and
listing the newly present constrained device on the list.

16. The method as recited in claim 15 further comprising including URL information for the newly present constrained device in the list.

17. The method as recited in claim 11 further comprising the gateway node receiving a periodically sent message from each of the constrained devices.

18. The method as recited in claim 11 further comprising the gateway node holding requests from the client node for one of the constrained devices until the gateway node receives a periodically sent message indicating that the one constrained device has turned on its receiver/transmitter circuit for a period of time.

19. The method as recited in claim 17 further comprising each of the constrained devices periodically waking up from a low power state in which the wireless receiver/transmitter circuit is turned off and sending the periodically sent message indicating that the constrained device has turned on its receiver/transmitter circuit for a period of time.

20. The method as recited in claim 19 further comprising each of the constrained devices returning to a low power state in which the wireless receiver/transmitter circuit is turned if no transmission is initiated to a respective one of the constrained devices during the period of time.

21. The method as recited in claim 17 wherein the gateway node automatically discovers a constrained device that is newly present on the wireless network utilizing a periodically sent message as an indicator of the presence of a constrained device and to populate the list of the one or more constrained devices with the newly present constrained device.

22. An apparatus comprising:
a gateway node wherein the gateway includes a web server;
the gateway node having a first network interface to communicate with a client node and a second network interface to communicate with one or more constrained devices over a wireless network; and
wherein the gateway node is configured to automatically discover a constrained device that is newly present on the wireless network utilizing a periodically sent message from a new constrained device as an indicator of the presence of the new constrained device and to populate a list of the one or more constrained devices with the new constrained device.
